(19) United States
(12) Patent Application Publication
(10) Pub. No.: US 2026/0168467 A1
(43) Pub. Date: Jun. 18, 2026

(54) GAS INJECTOR COMPRISING A HYDRAULIC DAMPING DEVICE HAVING A FREE PATH

(71) Applicant: ROBERT BOSCH GMBH, Stuttgart (DE)

(72) Inventors: Dietmar SCHMIEDER, Markgroeningen (DE); Hubert Stier, Vaihingen/Enz (DE)

(21) Appl. No.: 18/707,817

(22) PCT Filed: Jul. 27, 2022
(86) PCT No.: PCT/EP2022/071081

§ 371 Date: May 6, 2024

(30) Foreign Application Priority Data
Nov. 4, 2021 (DE) 10 2021 212 419.4
Dec. 13, 2021 (DE) 10 2021 214 187.0

(51) Int. Cl. F02M 21/02

(52) U.S. Cl. CPC F02M 21/0251; F02M 21/0206; F02M 21/0215; F02M 21/0257

(57) ABSTRACT

A gas injector for injecting a gaseous medium. The gas injector includes: a closing element which opens and closes a passage opening at a sealing seat; a resetting element which resets the closing element to a closed initial position; an actuator which actuates the closing element; a hydraulic damping device for damping a movement of the closing element, wherein the hydraulic damping device is designed to use a liquid to provide a damping effect in a closed hydraulic chamber; and a free-path arrangement which is located between the closing element and the hydraulic damping device and is designed so that the movement of the closing element is damped only after a predefined free path has been traveled.

### FIELD

The present invention relates to a gas injector for injecting a gaseous medium, in particular hydrogen or natural gas or the like, with a hydraulic damping device having a free path in order to damp a movement of a valve needle, in particular not only during an opening process but also during a closing process.

### BACKGROUND INFORMATION

Gas injectors are described in the related art in different designs. Due to the gaseous medium that gas injectors inject, gas injectors must perform a very large stroke compared to injectors for liquid media, such as fuel injectors. However, with gas injectors, this can lead to major wear on components, in particular on a sealing seat and on a stroke limiter. The high switching forces required for gas injectors further increase wear on the components during operation.

### SUMMARY

A gas injector according to the present invention for injecting a gaseous medium, in particular for injecting hydrogen or natural gas, having features of the present invention has the advantage that, despite the large stroke due to the large volume of gas to be injected, a damping device can be provided in a very compact design and at low cost. The damping device also reduces wear on components of the gas injector. Furthermore, the gas injector according to the present invention has a significantly improved noise behavior, in particular when an end stop is struck during an opening process and when a sealing seat is closing during a closing process. According to an example embodiment of the present invention, this is achieved in that the gas injector has a closing element that opens and closes a passage opening at a sealing seat. The gas injector also comprises a resetting element that returns the closing element from the open state into a closed initial state. Furthermore, an actuator which actuates the closing element is provided, along with a hydraulic damping device. The hydraulic damping device is designed to damp the movement of the closing element. The damping is effected by means of a fluid that carries out a damping process in a closed hydraulic chamber of the damping device when the closing element is being opened and/or closed. Furthermore, a free-path arrangement is provided, which is functionally arranged between the closing element and the hydraulic damping device. The free-path arrangement is designed such that the damping of the movement of the closing element during both the opening process and the closing process is only performed after a predefined free path has been traveled. This makes possible a highly cost-effective and compact structure of the damping device. Due to the free path of the free-path arrangement, an opening process and a closing process are thus carried out first without damping and the damping device only engages after the free path has been traveled. Excessive wear on the contact components of the gas injector, in particular on the sealing seat and/or on a stop that limits the opening stroke of the gas injector, can thus be prevented. Furthermore, the hydraulic damping by means of the damping device results in significantly improved noise behavior during the opening and closing processes of the gas injector.

Preferred example embodiments and developments of the present invention are disclosed herein.

Further preferably, according to an example embodiment of the present invention, a complete opening stroke of the closing element comprises the free path of the free-path arrangement and a damping path of the hydraulic damping device. The damping path of the hydraulic damping device is shorter than the free path.

Thus, for example, a very rapid opening with correspondingly large injection volumes is achieved during the opening process before the damping device damps the opening movement after the free path has been traveled, which slows down the opening process somewhat. In the same way, during a closing movement of the closing element, a large part of the closing path of the closing element is first traveled by travel along the free path until the hydraulic damping device engages and enables damping to prevent wear and noise when the closing element strikes the sealing seat.

A ratio of the damping path to the free path is preferably in a range from 0.06 to 0.12, in particular in a range from 0.08 to 0.10 and is particularly preferably 0.9.

Further preferably, according to an example embodiment of the present invention, the free-path arrangement comprises a free-path housing, a control element arranged in the free-path housing and a stop element fixed to the free-path housing, in particular a stop ring. The free path is formed between the control element and the stop element or, alternatively, between the control element and the free-path housing. As a result, the free-path arrangement can be formed highly compact and small.

Further preferably, according to an example embodiment of the present invention, the free-path housing is connected to the hydraulic damping device and the control element is connected to the closing element. Alternatively, the free-path housing is connected to the closing element and the control element is connected to the hydraulic damping device. The free-path arrangement is thus integrated between the closing element and the hydraulic damping device in the axial direction of the gas injector.

Further preferably, according to an example embodiment of the present invention, the hydraulic damping device comprises a base body and a centering bolt arranged axially movably in the base body, which is connected to the free-path arrangement. As a result, a connection between the hydraulic damping device and the free-path arrangement can be achieved in a simple manner via the centering bolt. The centering bolt preferably extends into the hydraulic damping device.

According to an example embodiment of the present invention, for the simplest possible structure, the hydraulic damping device has a first control chamber and a second control chamber, which are connected to one another via a fluidic connection. As a result, two control chambers are provided, wherein one control chamber is responsible for damping the opening movement of the closing element and the other control chamber is responsible for damping the closing movement of the closing element.

According to an example embodiment of the present invention, the fluidic connection between the first and second control chambers preferably comprises a restrictor. The restrictor is preferably arranged in a control cylinder that separates the first from the second control chamber. Damping of the closing element during the opening process and during the closing process is carried out via the restrictor by changing the volume in the first and second control chambers. The restrictor can, for example, take the form of a small hole in the control cylinder or alternatively or additionally be provided via radial gaps on the control cylinder.

Further preferably, according to an example embodiment of the present invention, the first and second control chambers are formed in the base body, in particular in a hole or the like that is open at one end and located in a central axis of the gas injector.

According to an example embodiment of the present invention, in order to achieve the most compact structure possible, the damping device preferably has a base body, a first flexible element and a second flexible element. The closing element is in connection with the first flexible element and the first and second flexible elements form housing regions of the closed hydraulic chamber. The first flexible element thus makes possible the movement of the closing element.

According to an example embodiment of the present invention, the first and second flexible elements are preferably a metal membrane. Alternatively, the first and second flexible elements are metallic bellows.

Further preferably, according to an example embodiment of the present invention, the first flexible element is arranged on the base body of the damping device in such a way that a first sub-chamber of the hydraulic chamber is formed between the base body and the first flexible element. Furthermore, the second flexible element is arranged on the base body in such a way that a second sub-chamber of the hydraulic chamber is formed between the base body and the second flexible element. The first and second sub-chambers are in fluidic connection with one another via a connecting region, preferably a groove or a hole or the like.

Further preferably, according to an example embodiment of the present invention, the first and second control chambers are connected to the connecting region by means of a transverse hole.

In order to minimize the influence of temperature on the damping device during operation, the damping device and the free-path arrangement are preferably arranged in the axial direction X-X of the gas injector at an end of the actuator facing away from the sealing seat. The actuator thus protects the damping device and the free-path arrangement from possible thermal influences, in particular if the gas injector is designed for direct injection into a combustion chamber of an internal combustion engine.

Further preferably, according to an example embodiment of the present invention, the gas injector is an outward-opening gas injector. The gas injector is preferably formed for direct injection of a gaseous fuel into a combustion chamber of an internal combustion engine.

In order to provide a unit that is as compact as possible and can be pre-assembled, according to an example embodiment of the present invention, the hydraulic damping device is preferably formed with the free-path arrangement as a pre-assembled module. The pre-assembled module is preferably arranged in a control module housing through which the closing element is passed.

In order to prevent a major leakage from the first and second control chambers into the hydraulic chamber, according to an example embodiment of the present invention, the centering bolt is preferably guided by means of the first flexible element, in particular a metal membrane, and a sealing washer. The sealing washer is preloaded in the axial direction by means of a spring washer. Through this measure, the radial gaps in the damping device can be made very small, so that leakage via these radial gaps can be minimized.

According to an example embodiment of the present invention, the spring washer is preferably pot-shaped and comprises a retaining edge, cams projecting in the axial direction and axial apertures. The spring washer is preferably arranged in the second control chamber of the hydraulic damping device. Preferably, the spring washer exerts an axial force on the sealing washer, as a result of which the sealing washer seals against the base body of the hydraulic damping device.

Alternatively, according to an example embodiment of the present invention, the sealing washer described above is preferably pressed against the base body of the hydraulic damping device by means of a pressed-in washer. As a result, a very good seal can be achieved, in particular in the contact region between the sealing washer and the base body. The sealing washer guides the centering bolt together with the first flexible element, in particular a metal membrane. Preferably, a radius is formed on the inner circumference of the sealing washer. As a result, radial gaps can be made very small, so that leakage from the hydraulic chamber into the first and second control chambers via these radial gaps can be minimized. The pressed-in washer is connected to the base body by a press connection.

Preferably, a liquid-filled compensation chamber is provided at the radially outer circumference of the sealing washer.

Furthermore, the present invention relates to an internal combustion engine with a gas injector according to the present invention. The gas injector preferably injects hydrogen or natural gas or another fuel gas, in particular directly into a combustion chamber of the internal combustion engine.

### BRIEF DESCRIPTION OF THE DRAWINGS

In the following, preferred exemplary embodiments of the present invention are described in detail below with reference to the figures.

FIG. 1 shows a schematic sectional view of a gas injector according to a first preferred exemplary embodiment of the present invention.

FIG. 2 shows a schematic, enlarged partial sectional view of a damping device and a free-path arrangement of the gas injector of FIG. 1 in the closed state of the gas injector.

FIG. 3 shows a schematic, enlarged partial sectional view of a damping device and a free-path arrangement of the gas injector of FIG. 1 in the partially open state after the free path has been traveled.

FIG. 4 shows a schematic, enlarged partial sectional view of a damping device and a free-path arrangement of the gas injector of FIG. 1 in the fully open state after the free path has been traveled.

FIG. 5 shows a schematic, enlarged partial sectional view of a damping device and a free-path arrangement of the gas injector of FIG. 1 in the partially closed state after the free path has been traveled.

FIG. 6 shows a schematic partial sectional view of a damping device and a free-path arrangement of a gas injector according to a second exemplary embodiment of the present invention in the closed state.

FIG. 7 shows a schematic partial sectional view of a damping device and a free-path arrangement of a gas injector according to a third exemplary embodiment of the present invention in the closed state.

FIG. 8 shows a schematic partial sectional view of a damping device and a free-path arrangement of a gas injector according to a fourth exemplary embodiment of the present invention in the closed state.

FIG. 9 shows a schematic sectional view of the spring washer in FIG. 8.

FIG. 10 shows a schematic top view of the spring washer of FIG. 9.

FIG. 11 shows a schematic partial sectional view of a damping device and a free-path arrangement of a gas injector according to a fifth exemplary embodiment of the present invention in the closed state.

### DETAILED DESCRIPTION OF EXAMPLE EMBODIMENTS

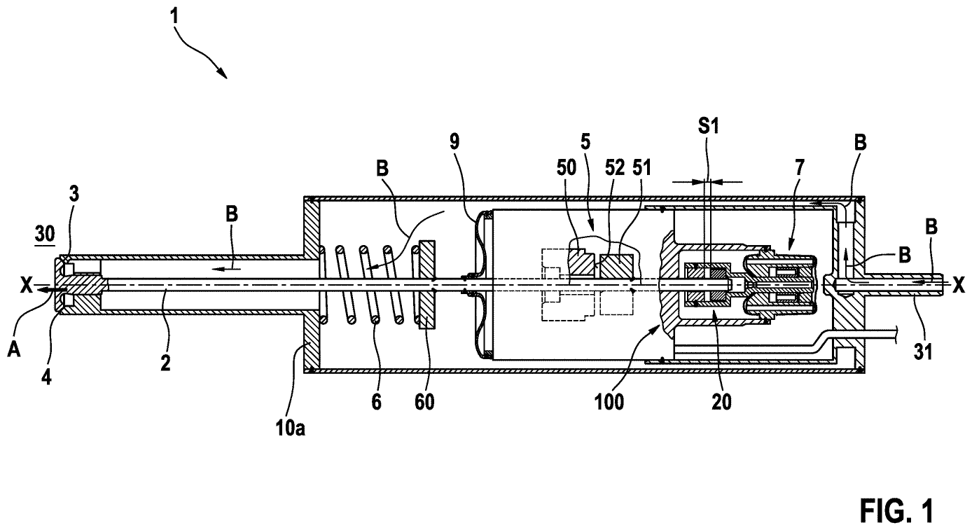

With reference to FIGS. 1 to 5, a gas injector 1 according to a first preferred exemplary embodiment of the present invention is described in detail below.

As can be seen in FIG. 1, the gas injector for injecting a gaseous medium into a combustion chamber 30 of an internal combustion engine comprises a closing element 2 and an actuator 5 for actuating the closing element 2. The closing element 2 is a valve needle. The actuator 5 is a magnetic actuator with an inner pole 50 and an armature 51 connected to the closing element 2. A stop 52 is formed on the inner pole 50 to limit the opening stroke of the closing element.

The closing element 2 opens up a passage opening 4 at a sealing seat 3 and closes it. In the open state, the passage opening 4 is an annular passage, wherein the gas injector 1 is an outward-opening injector. That is to say, the closing element 2 is moved outwards in the direction of arrow A towards the combustion chamber 30 in order to open it.

A gas inlet 31 is provided at the opposite end of the sealing seat 3. As can be seen in FIG. 1, the gas inlet 31 is arranged in line with the closing element 2 on a central axis, which defines an axial direction X-X of the gas injector.

In FIG. 1, the arrows B indicate the gas flow through the gas injector 1 from the gas inlet 31 to the sealing seat 3.

As can also be seen in FIG. 1, the actuator 5 is closed against the gaseous medium by means of a metal membrane 9. The metal membrane 9 is connected to the closing element 2 by means of a welded connection. The metal membrane 9 has a central opening through which the closing element 2 is passed.

Furthermore, the gas injector 1 comprises a resetting element 6, which in this exemplary embodiment is a cylindrical coil spring. The resetting element 6 returns the closing element 2 from the open state to the closed initial state. The resetting element 6 is supported on a spring plate 60 and a housing component 10a.

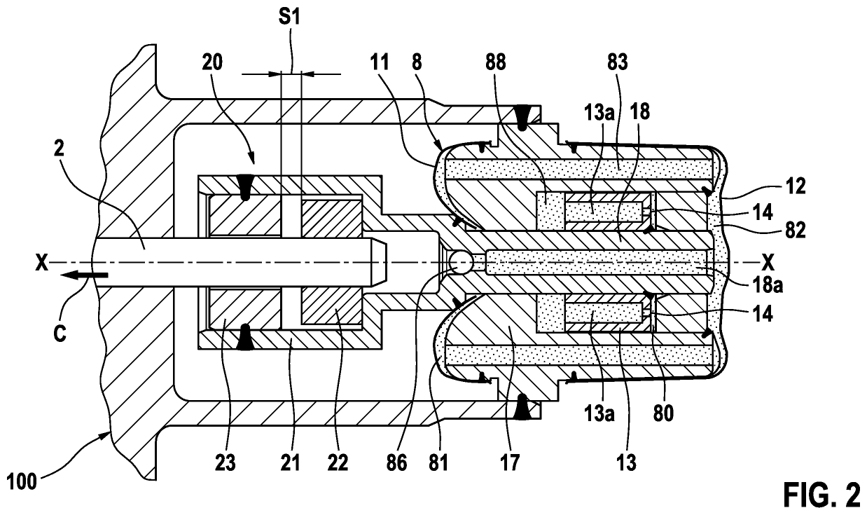

The gas injector 1 also comprises a hydraulic damping device 7, which is described in detail with reference to FIGS. 2 to 5.

The hydraulic damping device 7 is designed to damp the movement of the closing element 2. Movements during the opening process and during the closing process are damped. The hydraulic damping device is designed to carry out the damping by means of a fluid in a closed hydraulic chamber 8 of the damping device 7.

The hydraulic damping device 7 comprises a first control chamber 80 and a second control chamber 88. The two control chambers 80, 88 are arranged in a base body 17 of the hydraulic damping device 7. The first control chamber 80 is used to damp a resetting movement of the closing element and the second control chamber 88 is used to damp an opening movement of the closing element.

As can be seen in FIG. 2, a control cylinder 13 is arranged on a centering bolt 18. The control cylinder 13 has a plurality of holes 13a, which connect the first control chamber 80 to the second control chamber 88. In each case, a restrictor 14 is formed in the holes, wherein the strength of the damping during the opening and closing process can be adjusted by selecting a hole diameter for the restrictors 14.

Furthermore, the damping device 7 comprises a first flexible element 11 and a second flexible element 12. In this exemplary embodiment, the first and second flexible elements 11, 12 are metal membranes. As can be seen in FIG. 2, the enclosed hydraulic chamber 8 is formed by cavities in the base body 17 and the first and second flexible elements 11, 12. The first flexible element 11 is provided with a central opening through which the centering bolt 18 is passed. The first flexible element 11 is connected to the centering bolt 18 by means of a welded connection.

The closed hydraulic chamber 8 is filled with a liquid, for example oil. As can be seen in FIG. 2, the centering bolt 18 is formed with a throughhole 18a, which is closed by a ball 86. This makes easy filling of the closed hydraulic chamber 8 possible.

The second flexible element 12 is arranged in a fluid-tight manner on the end face of the base body 17 directed towards the gas inlet 31. Since the first and second flexible elements 11, 12 are preferably metal membranes, a fluid-tight seal with the base body 17 can be established in a simple manner by means of welded connections.

A first sub-chamber 81 of the hydraulic chamber is formed between the base body 17 and the first flexible element 11. A second sub-chamber 82 is formed between the base body 17 and the second flexible element 12. The first and second sub-chambers are in fluidic connection with one another via a connecting region 83, which is a connecting hole.

Furthermore, the gas injector 1 comprises a free-path arrangement 20. The free-path arrangement 20 is arranged in the axial direction X-X between the hydraulic damping device 7 and the actuator 5 (see FIG. 1).

The free-path arrangement 20 comprises a free-path housing 21, a control element 22, which in this exemplary embodiment is a control washer, and a stop element 23. As can be seen in FIG. 2, the stop element 23 is firmly connected to the free-path housing 21 by means of a welded connection. The control element 22 is arranged on an end of the closing element 2 facing away from the combustion chamber 30. A fixed connection is provided between the control element 22 and the end of the closing element 2. This can be, for example, a welded connection or a press connection or any other fixed mechanical connection.

The free-path housing 21 is connected to the centering bolt 18, wherein the free-path housing 21 and the centering bolt 18 are formed, for example, as a single, common component. However, the structure of the free-path housing 21 and the centering bolt can also be multi-part.

The gas injector 1 also comprises a pot-shaped control module housing 100, in which the free-path arrangement 20 and, in part, the damping device 7 are arranged. The control module housing is connected to an outer circumference of the base body 17 of the damping device 7 by a welded connection.

The function of the gas injector 1 according to the present invention with a path-optimized damping function is as follows. Starting from the closed position of the gas injector 1 shown in FIGS. 1 and 2, the actuator 5 is actuated. As a result, the armature 51 is attracted in the direction of the inner pole 50, so that the closing element 2 lifts away from the sealing seat 3 and opens the passage opening 4. The resetting element 6 is preloaded.

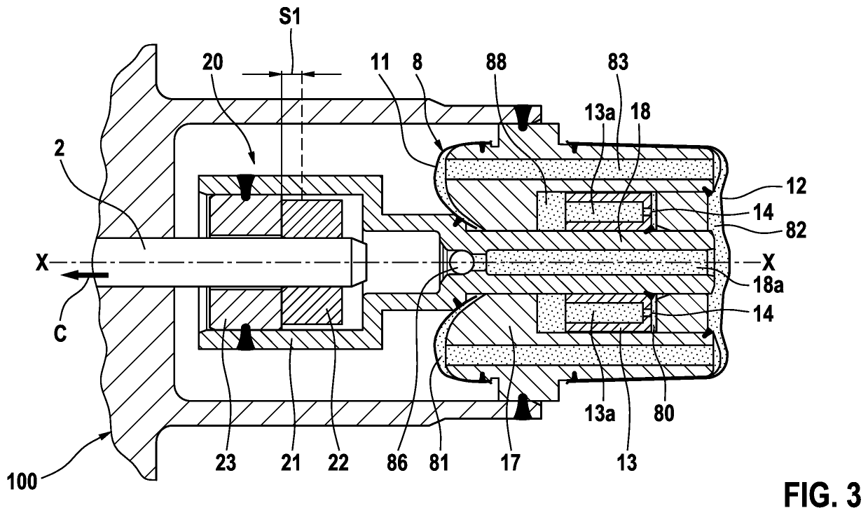

In FIG. 2, the opening process for the closing element 2 is indicated by arrow C. In the closed state of the gas injector, there is a free path S1 between the stop element 23 and the control element 22 in the axial direction. Since the control element 22 is connected to the closing element 2, this free path S1 is traveled during the opening process until the control element 22 strikes the stop element 23. This state is shown in FIG. 3.

Up until the state shown in FIG. 3, no damping whatsoever is carried out during the opening process of the gas injector. However, the gas injector is not yet fully open. For the remaining opening path of the gas injector, damping by the hydraulic damping device 7 is now carried out.

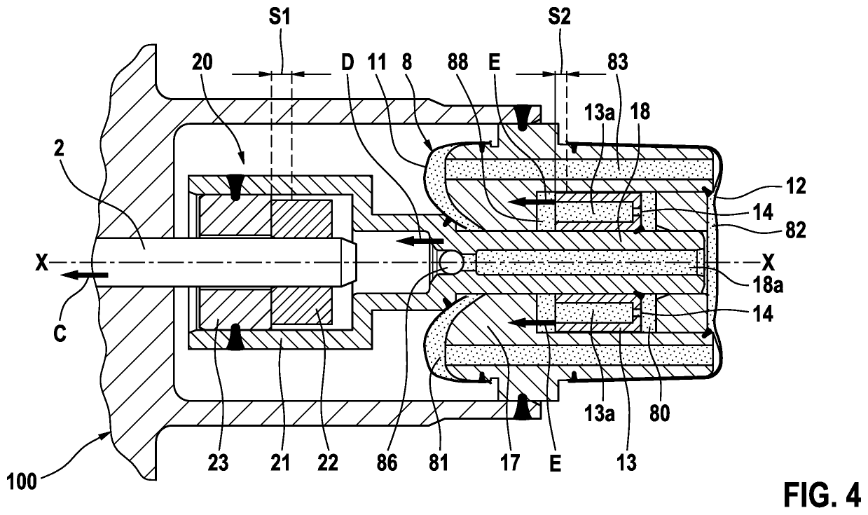

Since, as indicated by arrow C in FIG. 3, the closing element 2 is moved further in the opening direction, the contact between the control element 22 and the stop element 23 also moves the free-path housing 21 and thus also the centering bolt 18 in the direction of arrow C. This is indicated in FIG. 4 by the arrow D on the centering bolt 18. Since the control cylinder 13 is firmly connected to the centering bolt 18, this is also moved in the opening direction, as indicated by the arrows E. However, this changes the volume of the first control chamber 80 and of the second control chamber 88. More precisely, the volume of the first control chamber 80 increases and the volume of the second control chamber 88 decreases. Since the two control chambers 80, 88 are in fluidic connection with one another via the hole 13 and the restrictor 14, this results in a damping of the movement of the closing element until the armature 51 finally strikes the inner pole 50.

A damping path S2, which is traveled by the control cylinder 13, is shown in FIG. 4. The maximum opening stroke of the closing element 2 is thus the sum of the free path S1 and the damping path S2. The damping strength can be easily adjusted by selecting the hole diameters for the restrictors 14.

As can also be seen in FIG. 4, the volume of the first sub-chamber 81 and of the second sub-chamber 82 also changes, since the first flexible element 11 is directly connected to the centering bolt 18 moving in the axial direction X-X. More precisely, the volume of the first sub-chamber 81 increases and the volume of the second sub-chamber 82 decreases accordingly (see FIG. 4).

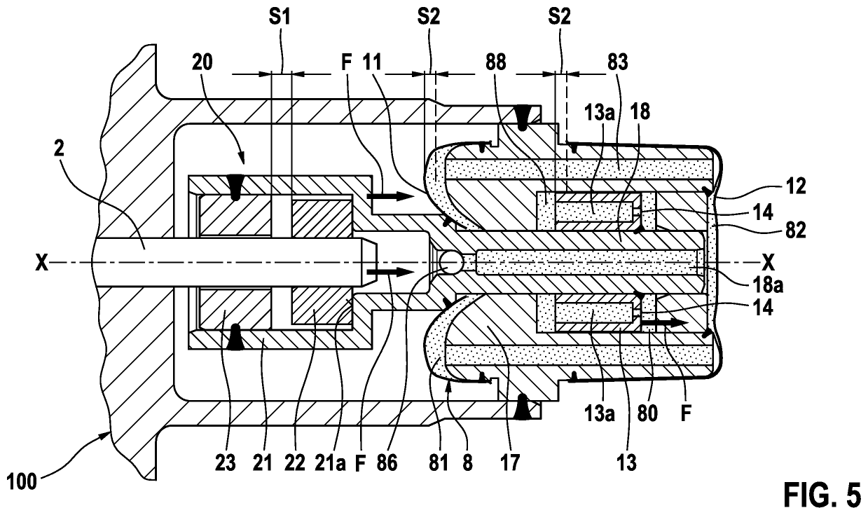

For the closing process of the gas injector, the energization of the actuator 5 is terminated, so that a resetting force is applied to the closing element 2 by the preloaded resetting element 6. FIG. 5 shows the first movement path for the resetting process, wherein the control element 22 connected to the closing element 2 first travels the free path S1 until it abuts a shoulder 21a of the free-path housing 21. This state is shown in FIG. 5. Up to this point in time during the resetting process, the hydraulic damping device 7 has no damping effect.

As soon as the control element 22 abuts the shoulder 21a of the free-path housing 21, the free-path housing 21 and thus also the centering bolt 18 connected to the free-path housing 21 are moved back by the resetting movement, which is still present, of the resetting element 6. As a result, the control cylinder 13 is also moved back to the initial position shown in FIG. 2. The return movements of the components are indicated by the arrows F in FIG. 5.

Thus, as soon as the control element 22 abuts the free-path housing 21, due to the movement of the centering bolt 18, damping by means of the hydraulic damping device 7 is carried out, since the volumes in the first control chamber 80 and second control chamber 88 equalize at the initial position shown in FIG. 2. The maximum damping distance S2 that must be traveled until the closing element 2 seals completely at the sealing seat 3 is indicated by a dashed line in FIG. 5. Thus, only the last movement is damped when the gas injector is being reset.

According to the present invention, damping during the opening process can thus be limited to the final opening path of the closing element by cleverly providing the free path S1 by means of the free-path arrangement 20. In the same way, during the closing process, a damping effect is limited by the hydraulic damping device 7 to the last axially traveled path of the closing element 2 (damping path S2). As a result, it is possible to form the hydraulic damping device 7 to be very small and particularly cost-effective in each case with only one flexible element 11, 12 at each end of the base body. Furthermore, an inner and outer diameter of the first and second control chambers 80, 88 is the same. As a result, the base body 17 in particular can have a very simple design. The mobility of the centering bolt 18 can be ensured by appropriately formed radial gaps between the centering bolt 18 and the base body 17 or the control element 22 and the base body 17. By selection of the gap height of the radial gaps on the centering bolt 18 or the control element 22, another option for influencing the damping effect is provided.

According to the present invention, the damping can thus be limited in each case to the final path section during the opening and closing of the gas injector. The free path S1 is longer than the damping path S2. As a result, rapid switching times can be achieved and, furthermore, an injection of gas can be carried out rapidly on a larger scale due to the first undamped movement of the closing element when opening. The same applies to the closing process, which is made possible to a large extent by the first undamped closing path.

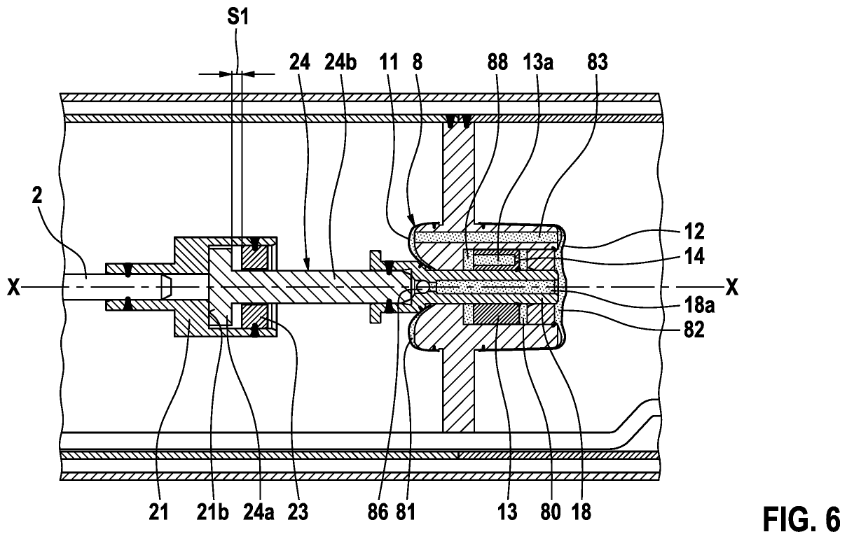

FIG. 6 schematically shows a partial sectional view of a gas injector according to a second exemplary embodiment of the present invention. Identical or functionally identical parts are denoted by the same reference signs as in the first exemplary embodiment.

In contrast to the first exemplary embodiment, in the second exemplary embodiment the free-path housing 21 is directly connected to the closing element 2. Furthermore, the free-path arrangement 20 comprises a control pin 24, which has a head 24a arranged in the free-path housing 21 and a shaft 24b connected to the centering bolt 18. The connection between the control pin 24 and the centering bolt 18 can be realized, for example, by means of a welded connection. In the second exemplary embodiment, during the opening process, the free-path housing 21 is thus first moved together with the closing element 2 until the free path S1 has been traveled. The head of the control pin 24 then abuts the stop element 23, so that the control pin 24 is also moved in the axial direction during the further opening movement of the closing element 2. Since the control pin 24 is firmly connected to the centering bolt 18, damping is then carried out by the hydraulic damping device 7 during the remaining opening path, as described in the first exemplary embodiment. During the closing process, as in the first exemplary embodiment, the control pin 24 first travels the free path S1 until the head of the control pin 24 abuts the free-path housing 21 with a stop face 21b and then a reset of the centering bolt 18 is enabled via the control pin 24. The final closing path of the closing element 2 is then also damped by the damping device 7. Otherwise, this exemplary embodiment corresponds to the first exemplary embodiment, so that reference can be made to the description given there.

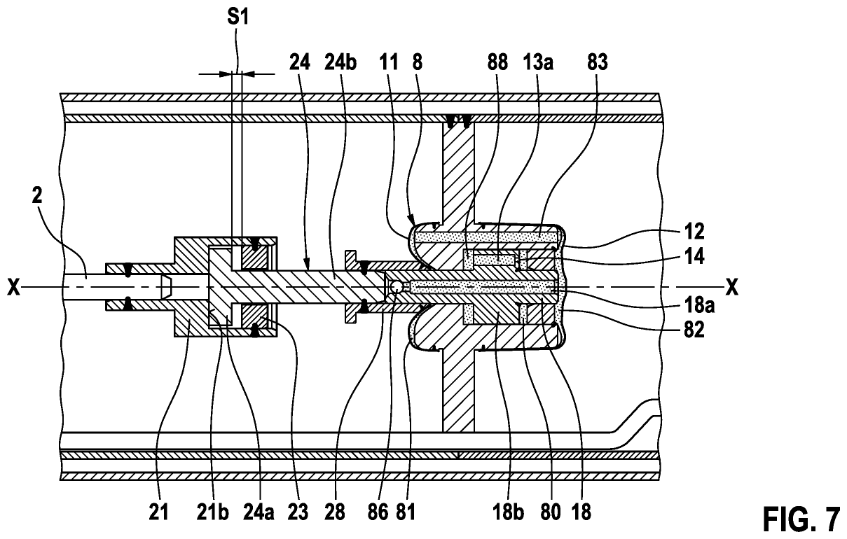

FIG. 7 shows a partial sectional view of a gas injector according to a third exemplary embodiment of the present invention. Identical or functionally identical parts are again designated with the same reference signs as in the previous exemplary embodiments.

The third exemplary embodiment substantially corresponds to the second exemplary embodiment, wherein the free-path arrangement 20 also comprises a control pin 24. However, in the third exemplary embodiment, the centering bolt 18 is formed in two parts, wherein a sleeve 28 is provided to connect the centering bolt 18 to the control pin 24. Furthermore, in the third exemplary embodiment, the control cylinder present in the first two exemplary embodiments is formed in one piece with the centering bolt 18, which is indicated in FIG. 7 by the reference sign 18b. Otherwise, this exemplary embodiment corresponds to the preceding exemplary embodiment, and so reference may be made to the description given therein.

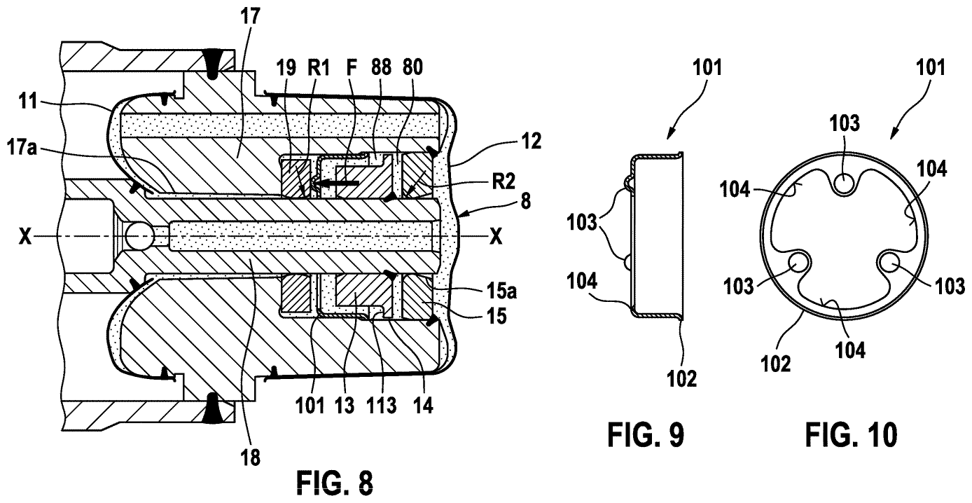

FIGS. 8 to 10 show a gas injector according to a fourth exemplary embodiment of the present invention. Identical or functionally identical parts are designated with the same reference signs as in the previous exemplary embodiments.

Compared to the previous exemplary embodiments, the fourth exemplary embodiment makes possible a reduction in leakage into the hydraulic chamber 8 from the first control chamber 80 and from the second control chamber 88. A reliable function of the hydraulic damping device 7 can thus be ensured, especially over a very long operating time. In contrast to the previous exemplary embodiments, the fourth exemplary embodiment has a modified guide for the centering bolt 18. As can be seen in FIG. 8, the centering bolt 18 is guided on a sealing washer 19. The sealing washer 19 has a radius R1 on an inner circumferential region, so that a contact line is formed between the sealing washer 19 and the centering bolt 18 for guidance. As a result, the gap in the region between the sealing washer 19 and the centering bolt 18 can be kept very small.

A spring washer 110 is also provided, which exerts a spring force F on the sealing washer 19 in the axial direction X-X. As a result, an axial seal between the sealing washer 19 and the base body 17 of the hydraulic damping device 7 is created.

As can be seen in detail in FIGS. 9 and 10, which show the spring washer 110 in sectional view (FIG. 9) and in top view (FIG. 10), the spring washer 101 has a substantially pot-shaped form, wherein the base has a central opening through which the centering bolt 18 is passed. The spring washer 101 comprises a retaining region 102, which is arranged on an outer circumference of the spring washer 101 and is fastened to the base body 17 in a force-fitting manner. Furthermore, three cams 103 are provided, which are arranged at equal distances (see FIG. 10) of 120° and are in contact with the sealing washer 19. The spring force F is exerted on the sealing washer 19 via the cams 103. Apertures 104 are provided between the cams, in order to, during the movement of the centering bolt 18, make possible sufficient movement of the centering bolt in the axial direction X-X.

The control cylinder 13 is arranged at least partially in the pot-shaped spring washer 101. As can be seen in particular in FIG. 8, the control cylinder 13 has a radially outwardly directed flange 113, wherein a restrictor gap 14 is formed between the flange 113 and the base body 17. The fluid can flow from the first control chamber 80 into the second control chamber 88 and vice versa via this restrictor gap 14.

Furthermore, a sealing ring 15 is provided, on the inner circumference of which a second radius R2 and a cone 15a are formed. As a result, the first control chamber 80 is relatively well closed off from the hydraulic chamber 8.

As can also be seen in FIG. 8, a cone 17a is formed on the base body 17 between the base body and the centering bolt 18, so that fluid from the hydraulic chamber 8 reaches up to the sealing washer 19. As a result, a particularly good mobility of the centering bolt 18 is ensured.

The first flexible element 11, which is connected to the centering bolt 18, has a relatively high radial rigidity. For this reason, the first flexible element 11 cannot compensate for radial tolerances, or can do so only to a limited extent.

According to the fourth exemplary embodiment, the centering bolt 18 is now guided radially on the sealing washer 19. A very small radial gap can be realized.

By providing the cone 17a on the base body 17 and the cone 15a on the sealing ring 15, any possible misalignment of the centering bolt 18 that may occur during operation can be effectively compensated for. A cone angle is preferably in each case in the range of 0.5° to 30°, in particular 1° to 10°.

Otherwise, this exemplary embodiment corresponds to the previous exemplary embodiments, so that reference can be made to the description given there.

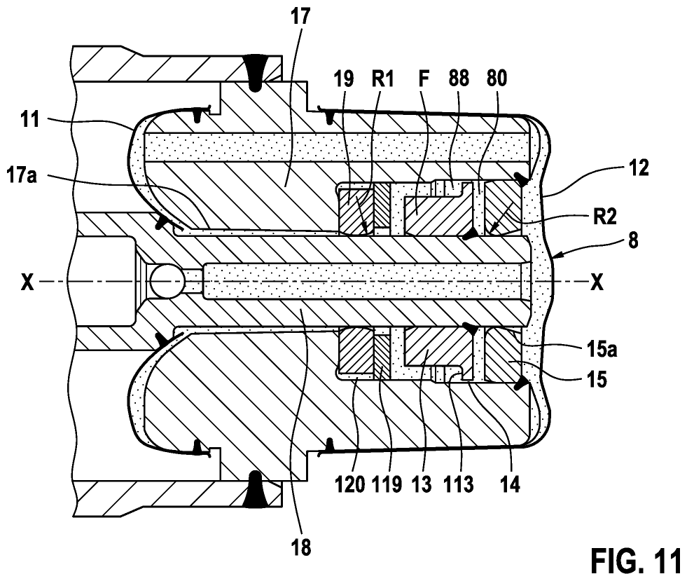

With reference to FIG. 11, a gas injector according to a fifth embodiment of the present invention is described in detail below. Identical or functionally identical parts are designated with the same reference signs as in the previous exemplary embodiments.

The fifth exemplary embodiment substantially corresponds to the fourth exemplary embodiment, wherein instead of the spring washer used in the fourth exemplary embodiment, a pressed-in washer 119 is used in the fifth exemplary embodiment, in order to press the sealing washer 19 against the base body 17 of the hydraulic damping device 7. A press connection is formed between the pressed-in washer 119 and the base body 17. As in the fourth exemplary embodiment, the sealing washer 19 guides the centering bolt 18 on an inner circumferential region, which has the radius R1. Radially on the outer circumference, a chamber 120 filled with fluid remains on the sealing washer 19, so that the centering bolt can also perform compensating movements in the radial direction if necessary. Otherwise, this exemplary embodiment corresponds to the previous exemplary embodiments, so that reference can be made to the description given there.

1-18. (canceled)

19. A gas injector for injecting a gaseous medium, comprising:
a closing element configured to open and close a passage opening at a sealing seat;
a resetting element configured to return the closing element to a closed initial position;
an actuator configured to actuate the closing element;
a hydraulic damping device configured to damp a movement of the closing element, wherein the hydraulic damping device is configured to provide damping using a fluid in a closed hydraulic chamber; and
a free-path arrangement arranged between the closing element and the hydraulic damping device and is configured to perform a damping of a movement of the closing element only after a predefined free path has been traveled.

20. The gas injector according to claim 19, wherein a complete opening stroke of the closing element includes the free path and a damping path of the hydraulic damping device.

21. The gas injector according to claim 20, wherein the damping path is shorter than the free path.

22. The gas injector according to claim 21, wherein a ratio of the damping path to the free path is in a range from 0.06 to 0.12.

23. The gas injector according to claim 19, wherein the free-path arrangement includes a free-path housing, a control element arranged in the free-path housing, and a stop element fastened to the free-path housing, and wherein:
the free path is formed between the control element and the stop element, or
the free path is formed between the control element and the free-path housing.

24. The gas injector according to claim 23, wherein:
the free-path housing is connected to the hydraulic damping device and the control element is connected to the closing element, or
the free-path housing is connected to the closing element and the control element is connected to the hydraulic damping device.

25. The gas injector according to claim 19, wherein the hydraulic damping device includes a base body and a centering bolt arranged axially moveably in the base body, wherein the centering bolt is in operative connection with the free-path arrangement.

26. The gas injector according to claim 19, wherein the hydraulic damping device has a first control chamber and a second control chamber, which are in connection with one another via a fluidic connection.

27. The gas injector according to claim 26, wherein the fluidic connection includes a restrictor, which is arranged in a control cylinder that separates the first control chamber from the second control chamber, wherein damping of the closing element during an opening process and during a closing process is carried out via the restrictor by changing a volume in the first and second control chambers.

28. The gas injector according to claim 19, wherein the damping device has a base body, a first flexible element, and a second flexible element, wherein the closing element is in connection with the first flexible element and the first flexible element and the second flexible element form housing regions of the closed hydraulic chamber.

29. The gas injector according to claim 28, wherein: (i) the first and/or second flexible element are metal membranes, and/or (ii) the first and second flexible elements are bellows.

30. The gas injector according to claim 28, wherein the first flexible element is arranged on the base body in such a way that a first sub-chamber of the hydraulic space is formed between the base body and the first flexible element, and wherein the second flexible element is arranged on the base body in such a way that a second sub-chamber of the hydraulic chamber is formed between the base body and the second flexible element, wherein the first and second sub-chambers are in fluidic connection with one another via a connecting region.

31. The gas injector according to claim 19, wherein the free-path arrangement and the damping device are arranged in an axial direction of the gas injector at an end of the actuator facing away from the sealing seat.

32. The gas injector according to claim 31, wherein the free-path arrangement and the hydraulic damping device are formed as a pre-assembled module.

33. The gas injector according to claim 25, wherein the centering bolt is guided by a first flexible element and a sealing washer, wherein the sealing washer is preloaded using a spring washer.

34. The gas injector according to claim 33, wherein the spring washer is pot-shaped including a retaining edge, cams projecting in an axial direction, and axial apertures.

35. The gas injector according to claim 25, wherein the centering bolt is guided by a first flexible element and a sealing washer, wherein the sealing washer is preloaded in an axial direction using a pressed-in washer, which is connected to the base body of the hydraulic damping device by a press connection.

36. The gas injector according to claim 35, wherein a liquid-filled compensation space is provided at a radially outer circumference of the sealing washer.
